(19) United States
(12) Patent Application Publication
(10) Pub. No.: US 2012/0181465 A1
(43) Pub. Date: Jul. 19, 2012

(54) COMPACT CARTRIDGE COUPLING

(76) Inventor: Paolo Rusconi, Rivolta D'Adda (IT)

(21) Appl. No.: 13/181,217

(22) Filed: Jul. 12, 2011

(30) Foreign Application Priority Data
Jul. 16, 2010 (EP) 10425240.8

(51) Int. Cl. F16L 37/28; F16L 37/33

(52) U.S. Cl. 251/149.6; 137/614.04

(57) ABSTRACT

The present invention relates to a compact cartridge coupling of the type adapted to connect a pressurized fluid line between a vehicle or apparatus and a utility, which coupling is of the type comprising a female half-coupling adapted to accommodate a male half-coupling.

The cartridge coupling according to the present invention is characterized in that it comprises decompression means adapted to reduce the pressure within the line and is further characterized in that it comprises mechanical blocking means adapted to avoid the two half-couplings from involuntarily closing.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a compact cartridge coupling.

Quick couplings according to ISO 7541 standard are nowadays consolidated on the world market, especially in the farming/forestry field. ISO standards govern the dimensions of couplings to ensure interchangeability between different manufacturers, coupling ability and various minimum use requirements, such as pressure, flow rate and so on.

Among the quick couplings according to the mentioned standard, cartridge couplings are characterized by a compact design while keeping the same functional principles of ISO 7241 standard.

In particular, cartridge couplings may be inserted into a casing, commonly made of cast iron, in order to allow more effective use of the cartridge coupling under operating conditions contemplating high operating pressures, in particular also with sudden changes of flow direction and particularly high pressure pulsating frequencies.

Furthermore, cartridge couplings are generally employed by positioning them inside these cast iron casings when conditions of use contemplate the presence of earth, mud and debris, as precisely occurs, for example, in the case of use in the farming/forestry field.

One of the main drawbacks of the cartridge couplings of the prior art is thus related to non-optimal reliability, with particular reference to resistance and duration of the components and of the coupling as a whole.

Furthermore, an improvable aspect of cartridge couplings of the prior art relates to overall dimensions.

It is a main task of the present invention to either eliminate or reduce the above-mentioned drawbacks.

In the scope of this task, it is thus the object of the present invention to provide a quick cartridge coupling which is characterized by small overall dimensions, so as to be placed in narrow spaces.

It is a further object of the present invention to provide a quick cartridge coupling provided with a decompression system which allows to reduce the pressure inside the system, thus reducing the coupling and uncoupling loads.

This task and these and other objects which will be more apparent below are achieved by a cartridge coupling for connecting a pressurized fluid line between a vehicle or apparatus and a utility, comprising an outer casing in which a female half-coupling is inserted, comprising a front valve assembly and adapted to accommodate a male half-coupling, said casing comprising at least a clean oil recovery channel and a fouled oil draining channel, characterized in that it further comprises, on said female half-coupling, decompression means to reduce the pressure within the line, thus facilitating the coupling and uncoupling operations of the male half-coupling to/from said female half-coupling.

The cartridge coupling according to the present invention is further characterized in that said decompression means allow to reduce pressure in both the female part and the male part.

Again, the cartridge coupling according to the present invention is characterized in that it further comprises mechanical blocking means adapted to prevent the front valve assembly from closing when the male coupling is inserted and regardless of the flow direction and pressure in the line, and adapted to allow the extra travel of said valve assembly needed for completely inserting the male half-coupling.

### BRIEF DESCRIPTION OF THE DRAWINGS

Further features and advantages of the present invention will be more apparent from the following detailed description given by way of non-limitative example and shown in the accompanying drawings, in which:

FIG. 1 shows a section view with longitudinal plane of the cartridge coupling according to the present invention;

FIG. 2 shows an enlarged detail of the valve assembly of the cartridge coupling in FIG. 1, again in section with a longitudinal plane;

FIG. 3 shows in detail, again in longitudinal section, the decompression system of the cartridge coupling in FIG. 1;

FIG. 4 shows in detail, again in longitudinal section, the mechanical blocking system of the cartridge coupling in FIG. 1;

FIG. 5 shows, again in longitudinal section, the cartridge coupling in FIG. 1 on which a male half-coupling is engaged;

FIG. 6 shows a detail of the lever and cam actuating system of the decompression system of the cartridge coupling according to the present invention;

FIG. 7 shows, again in longitudinal section, a cartridge coupling according to the present invention in an engaged configuration with closed valves

### DETAILED DESCRIPTION

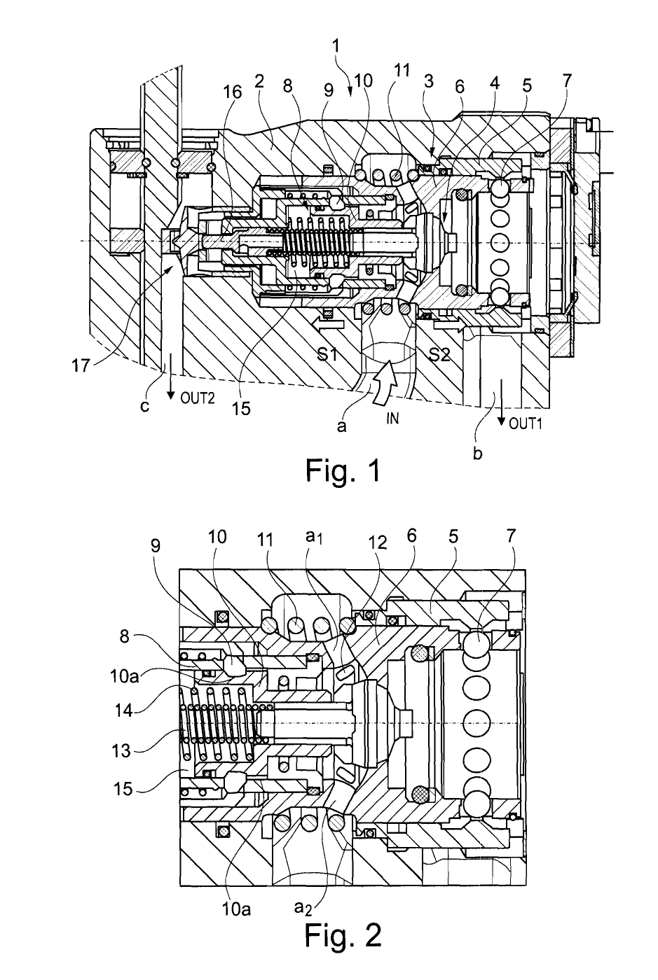

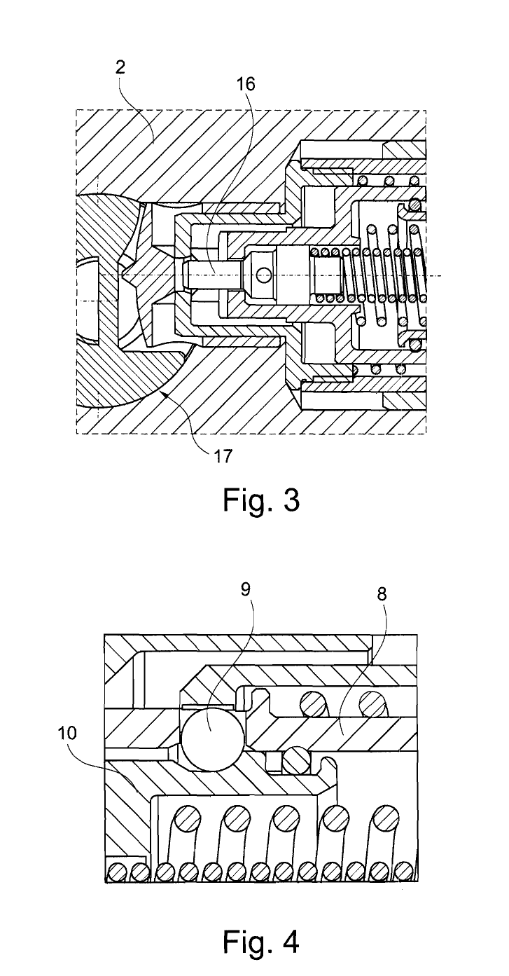

According to a preferred embodiment of the present invention shown in the mentioned figures by way of non-limiting example, the cartridge coupling 1 according to the present invention comprises an outer casing 2, preferably made of cast iron or other suitable material, in which a female half-coupling 3 is accommodated. Such a female half-coupling is of the type adapted to accommodate a male half-coupling and is preferably of the type responding to the features established by ISO 7241 standard. Several pipes are obtained in said outer casing 2 for the circulation of fluid, generally oil, which flows through the hydraulic line on which the half-couplings are inserted. In particular, with reference to FIG. 1, the fluid enters from the main feeding pipe a of the line according to the arrow indicated by IN thus feeding the female half-coupling 3. The system then provides for the recovery of the fouled oil by means of the front draining channel b, where the flow direction is represented by the OUT 1 arrow, while the clean oil is collected by means of the clean oil recovery channel c, OUT2, and recirculated.

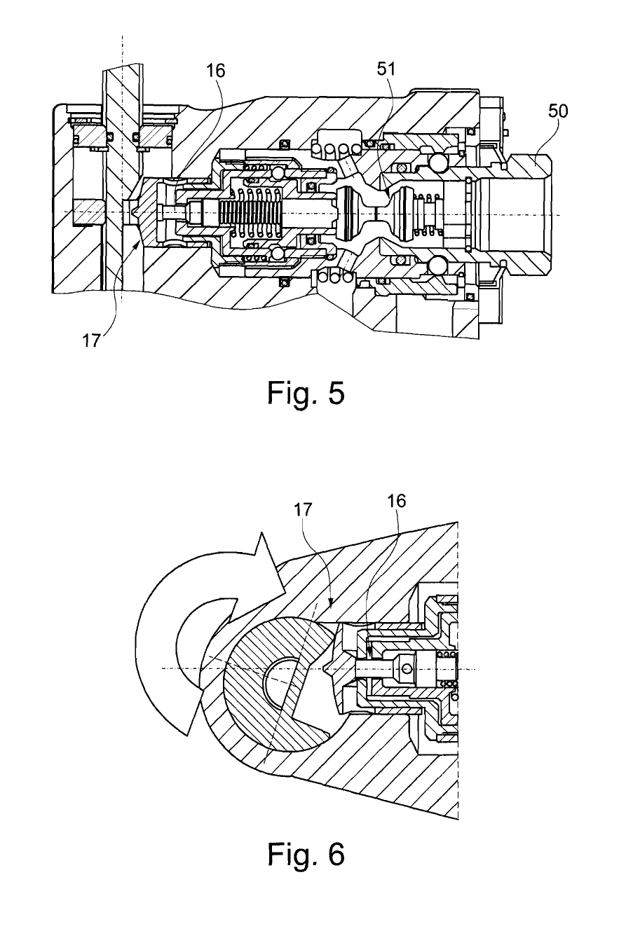

Said female half-coupling 3 comprises a ring nut 5, which is mechanically blocked with respect to the outer casing 2, the ball body 6 is capable of axially translating with respect to the body 2. The ball body 6, by virtue of the balls 7, is capable of ensuring the connection of the male half-coupling, as shown in FIG. 5, the balls 7 being capable of firmly holding the male half-coupling as known in the field.

The valve assembly 4, capable of adhering to the walls of the inner port obtained within the ball body 6 so as to close the axial passage to the fluid, is provided in a substantially axial position. As shown again in the accompanying figures, the main feeding pipe a carries the fluid to the zone of the rearming spring 11 and from this zone enters the female half-coupling through the pipes a1 and a2 and the radial passage holes 12 to reach the valve body 4. Until the male half-coupling is engaged, the valve body 4 closes the axial gap of the female half-coupling 3, as shown in FIGS. 1 and 2. In this situation, the valve assembly 4 is pushed closed by a first spring 13. The movable equipment of the female half-coupling 3 is completed by an inner body 8, on which a plurality of blocking balls 9 are radially provided, which allow the mechanical blocking of an inner slider 10, also axially movable and provided on the inner surface thereof with a plurality of seats 10a, in which the blocking balls 9 may be accommodated.

Again with reference to the figures, in particular to FIGS. 1 and 2, a chamber 15 which is filled with the pressurized fluid during the operation of the coupling, is present behind the valve assembly 4.

The valve assembly 4 is connected to a spring 13 acting between said valve assembly 4 and a decompression valve 16 placed in an axial position at the opposite end of the half-coupling 3 with respect to the front valve assembly 4. Said decompression valve 16 is, in turn, connected to cam and lever actuating means 17, which allow the opening of the decompression valve.

The operation of the cartridge coupling device according to the present invention will now be described again with reference to the accompanying figures.

The step of coupling and uncoupling the male half-coupling 50 in the female half-coupling 3 occurs with a single continuous maneuver. During the first step of coupling, the male part pushes on the balls 7 of the ball body 6 moving the front valve assembly 4, which opens the valve 16 placed on the rear part of the half-coupling 3. Thereby, a sudden lowering of the fluid pressure inside the female half-coupling 3 occurs. Once the pressure has been decreased, it is easier to proceed with the coupling maneuver because the user must sustain a lower effort to introduce the male half-coupling 50 in the female half-coupling 3. Continuing with the insertion in the male half-coupling 50, the valve body 4 continues to retract, being pushed by the valve assembly 51 of the male half-coupling, thus freeing the balls of the mechanical block 9.

The retraction of the valve body 4 indeed causes a retraction of the inner body 8 and the consequent disengagement of the blocking balls 9 from the seats 10a obtained on the inner slider 10 as well.

Once the mechanical blocking balls 9 have been released, the equipment of the valve body 4 may perform the extra travel towards the rear part of the half-coupling which is required to complete the engagement of the pressurized male.

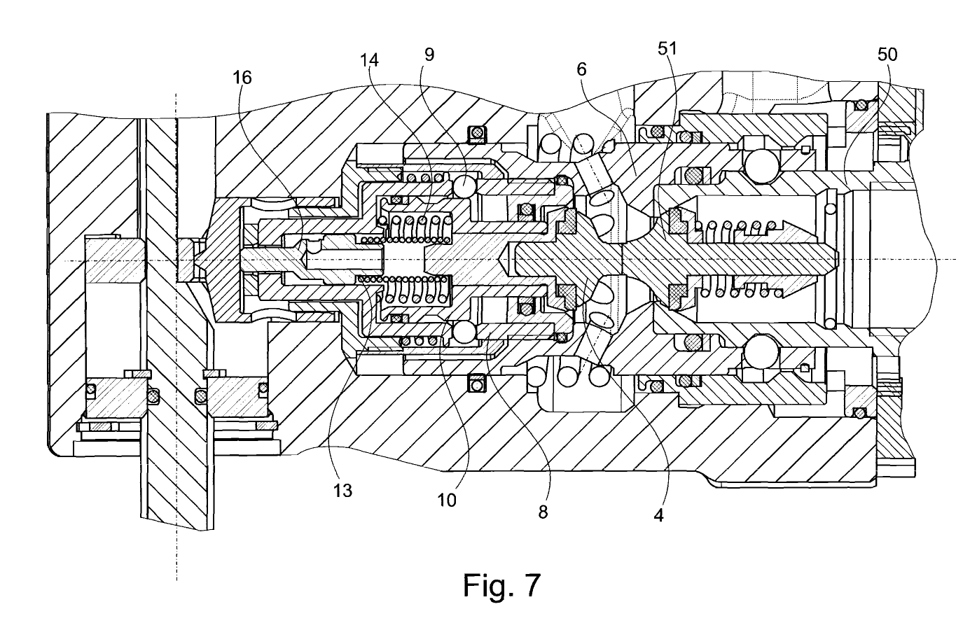

Such a situation is shown in FIG. 7, which shows the system in the configuration in which the male half-coupling 50 is fully inserted in the female half-coupling 3 and the valve body 4 abuts against the movable equipment of the female half-coupling, so that the valve assembly 51 closes the line.

The retraction of the valve body 4 causes the inner slider 10 and the inner body 8 also to retract, with the consequent compression of the springs 13 and 14, which are thus loaded, and the opening of the valve 16.

As apparent in FIG. 7, the mechanical blocking balls 9 have exited from the seat 10a, thus allowing the movement of the inner slider 10.

In this system configuration, the coupling of the male half-coupling 50 has been completed and the female half-coupling 3 may be pressurized. The fluid fills the chamber 15 provided inside the inner body 8, the pressure of the fluid exerting an axial thrust on the inner slider 10 which moves forward, i.e. it axially moves towards the end of the female half-coupling 3 intended to accommodate the male half-coupling 50, pushing the valve body 4 forward, thus determining the retraction of the valve body 51 of the male half-coupling towards the interior of the male half-coupling 50, thus causing the opening of the line.

In order to carry out the uncoupling operation with the line being pressurized, acting on the lever actuating means 17 is possible so as to manually open the decompression valve 16. Thereby, even if the male is still pressurized and the pressurized fluid is still present in the chamber 15 of the female half-coupling 3, the pressure in the chamber 15 may be reduced, thus facilitating the disconnection operation, because it allows the retraction of the valve body 4 of the female half-coupling, which allows the valve assembly 51 of the male half-coupling to be closed. Thereby, even if the pressurized fluid is still present in the half-coupling, the user may easily proceed and disconnect the two half-couplings.

Naturally, as mentioned, opening the decompression valve 16 allows to drain the line through the clean oil pipe c and to recover it in the hydraulic circuit.

The user can therefore choose whether to employ the cam and lever actuating means 17 also during the coupling operation, described above without referring to the use of said means.

According to a preferred embodiment of the present invention shown in the accompanying figures, the decompression valve 16 is characterized by a metal seal system of the cone-on-edge type on the inner body 8, obtained by upsetting the cone of the decompression valve on the rear edge of the inner body 8.

Again, the cartridge coupling according to the present invention includes a 2:1 balancing system of forces acting on the valves of the female half-coupling and of the male half-coupling, so as to further facilitate the coupling of a pressurized male. Such a balancing is obtained by conveniently dimensioning the diameter of the inner slider 8, on the crown of which the pressure force due to the fluid in chamber 15 acts according to the arrows F in FIG. 5, and of the valve assembly 51, on the crown of which the pressure of the fluid acts according to the arrows shown by M, again in FIG. 5. By conveniently dimensioning the thrust crown of the inner slider 8, a 2:1 ratio of the thrust forces due to the fluid pressure is obtained to the benefit of the thrust acting on the valve assembly 4 of the female half-coupling. This imbalance facilitates the opening of the valve assembly 51 and of the male alike when the male half-coupling is pressurized.

It has thus been shown that the cartridge coupling according to the present invention, characterized by a compact design and reduced dimensions which allow its positioning in narrow spaces, allows to achieve the prefixed task and objects.

In particular, it has been shown that the cartridge coupling according to the present invention allows to reduce the coupling and uncoupling loads, thus facilitating the coupling and uncoupling operations even when pressurized fluid is present in the line, regardless of whether the pressurized fluid is either in the male half-coupling or in the female half-coupling.

Again, the cartridge coupling according to the present invention allows to also reduce the amount of drawn oil drained through the pipe b because the coupling and uncoupling operations are optimized thus reducing the losses of fouled oil.

Many changes may be made by a person skilled in the art without departing from the scope of protection of the present invention.

Therefore, the scope of protection of the claims should not be limited to the illustrations or preferred embodiments described by way of example, but rather the claims should include all the features of patentable novelty inferable from the present invention, including all the features which would be treated as equivalents by a person skilled in the art.

What is claimed is:

1. A cartridge coupling of the type adapted to connect a pressurized fluid line between a vehicle or apparatus and a utility, comprising an outer casing in which a female half-coupling is inserted, comprising a front valve assembly and adapted to accommodate a male half-coupling also provided with a valve assembly, said casing comprising at least one main feeding channel, a clean oil recovery channel and a fouled oil draining channel, and further comprising, on said female half-coupling, decompression means to reduce the pressure within the line thus facilitating the coupling and uncoupling operations of the male half-coupling to/from said female half-coupling, further comprising mechanical blocking means acting on said valve assembly and adapted, when said male half-coupling is inserted in said female half-coupling, to prevent the valve assembly of said female half-coupling from closing regardless of flow direction and pressure intensity of the fluid in the line, characterized in that said mechanical blocking means comprise at least one or more mechanical blocking balls supported by an inner body and adapted to be selectively accommodated in appropriate seats obtained on the outer surface of an inner slider also axially movable, said inner body and said inner slider being coaxial to each other and coaxial to said front valve assembly.

2. A cartridge coupling according to the preceding claim, wherein said decompression means comprise a decompression valve placed in a substantially axial position at the opposite end of said half-coupling with respect to the front valve assembly and adapted to drain the oil in said clean oil recovery channel.

3. A cartridge coupling according to the preceding claim, wherein said decompression valve may also be manually actuated by means of cam and lever actuating means.

4. A cartridge coupling according to claim 1, wherein behind said front valve assembly, delimited by the inner walls of said inner slider, a chamber is provided, adapted to be filled with the pressurized fluid when the coupling is operating.

5. A cartridge coupling according to claim 2, wherein said decompression valve forms a metal seal of the cone-on-edge type on said inner body.
